(19) United States
(12) Patent Application Publication
(10) Pub. No.: US 2004/0091112 A1
(43) Pub. Date: May 13, 2004

(54) Piracy reduction method for digital content

(76) Inventor: Donald L. Schilling, Palm Beach Gardens, FL (US)

Correspondence Address: John Gabrysiak, ORLOVSKY, MOODY, SCHAAF & GABRYSIAK, 187 Highway 36, West Long Branch, NJ, 07764, US

(21) Appl. No.: 10/293,249

(22) Filed: Nov. 13, 2002

(51) Int. Cl. H04N 7/167

(52) U.S. Cl. 380/210

(57) ABSTRACT

An improvement for television channel distribution having digitized-compressed content. The digitized-compressed content are security encoded with a first Gold-code signal. A code-adjust signal and a header are multiplexed to the encoded-digitize-compressed content, to generate a packetized-compressed-video signal. At a set-top box, the header and the code-adjust signal are read from the packetized-compressed-video signal. From the code-adjust signal read from the packetized-compressed-video signal, a second Gold-code signal is generated at the set-top box, synchronized from the code-adjust signal. The encoded-digitized-compressed content are decoded with the second Gold-code signal, thereby generating digitized-compressed content. The digitized-compressed content is decompressed as content.

### BACKGROUND OF THE INVENTION

This invention relates to cable and satellite distributed television and Internet signals, and more particularly to reducing piracy of digital content of the distributed television and Internet signals.

### DESCRIPTION OF THE RELEVANT ART

Cable and satellites serve as a medium for sending television (TV) and Internet signals to users in a community. The TV signals typically are sent to a head-end and then distributed throughout the community. All TV programs, each sent as a separate signal, are sent to each house, apartment, etc. The user selects which program to view, by selecting the appropriate channel. If 200 channels were used, for example, each with a symbol rate of one mega-symbols per second (Msymbols/sec), then a total symbol rate of 200 Msymbols/sec must be accommodated along the transmission path from the head-end to each user, even when no user is using the system.

Consider, that in a community of 1000 users, at least one user might be watching one of the most popular 20 channels, and a few might be watching another 10 channels. Only 30 Msymbols/sec are then required, and the remaining 170 Msymbols/sec could be used to provide high-speed access to video-on-demand, Internet or other content.

The owner, such as a movie studio, Blockbuster, etc., of content, would like to rent movies and other content to users. They would like to give a user a compact disk read-only-memory (CD ROM) for a limited time, or by downloading the content to the user over the Internet, or by transmitting the content over cable, fiber, or over a wireless transmission path to the user's set top box (STB). The content also could be transmitted over a satellite, to the user's Head End (HE) and then sent to the user's STB for viewing. Today, for each of the distribution methods or systems for the content, the user could copy the downloaded content onto a digital compact disk (CD) and then view the content for an unlimited time, or make additional, unauthorized copies of the content, and sell the unauthorized copies. The copying may result in royalties not being paid to the owner. Such copying is well known in the art, and referred to as “piracy”.

Satellite and cable companies try to prevent the unauthorized viewing and copying, by scrambling or encrypting a part or all of the content. The scrambling or encrypting employed today, assists in reducing the piracy, but not preventing it.

### SUMMARY OF THE INVENTION

A general object of the invention is to prevent unauthorized copying of downloaded content onto a digital-video recorder, or other copying or reproducing device.

A further object of the invention is to limit the number of times that the content can be viewed during a single rental and/or to limit the time, for example, the number of days, that the downloaded content can be viewed.

According to the present invention, as embodied and broadly described herein, an improvement to a television-content distribution system is provided. The television-content distribution system has digitized and probably compressed content. The term content, as used herein, refers to the digitized video and voice signal, as typically used for movies, etc. The improvement includes a Gold-code generator, a security encoder and code-adjust subsystem, a Forward Error Correction (FEC) encoder, a first header subsystem, a multiplexer, a second header subsystem, a start-of-data subsystem, a second Gold-code generator, a security decoder, a FEC decoder, and a decompressing subsystem. The first Gold-code generator generates a first Gold-code sequence signal. The security encoder encodes the digitized-compressed content with the first Gold-code signal. The security encoding produces an encoded-digitized-compressed content. The resulting security encoded-digitized-compressed content are then FEC encoded. The code-adjust sub-system generates a code-adjust signal. The first header subsystem generates a header with a user address. The multiplexer multiplexes the code-adjust signal and the header to the FEC encoded-digitize-compressed content. The resulting multiplexed signal is a packetized, compressed-video signal.

The second header subsystem, typically located at a use's STB, reads the header from the packetized-compressed-video signal. The start-of-data subsystem reads the code-adjust signal from the packetized-compressed-video signal. FEC decoding is then applied. Using the code-adjust signal read from the packetized-compressed-video signal, the second Gold-code generator generates a second Gold-code signal, with a code determined by the code-adjust signal. The security decoder decodes the security encoded-digitized-compressed content with the second Gold-code signal, thereby generating digitized-compressed content. The decompressing subsystem decompresses the digitized-compressed content as content.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 illustrates a packet of video-on-demand content being downloaded;

FIG. 2 is a block diagram of a Gold code generator with a code-adjust;

FIG. 3 is a block diagram for generating packetized, digital, compressed video;

FIG. 4 is a block diagram for decoding;

FIG. 5 illustrates the counter subsystem used to limit rental time; and

FIG. 6 shows a simplified block diagram at a RSU.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several view.

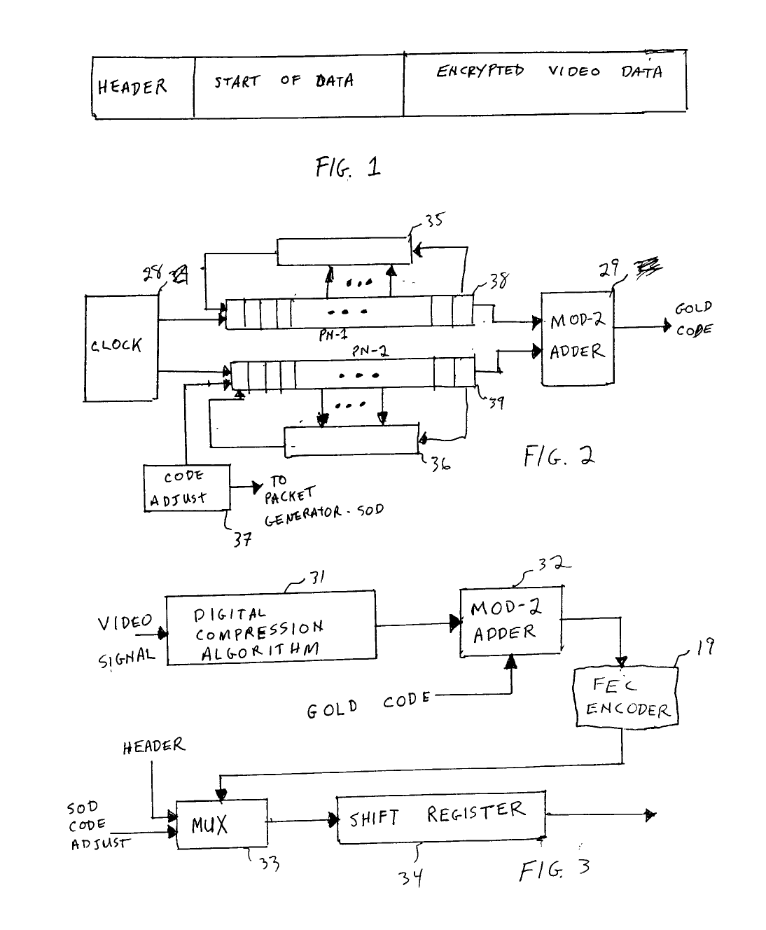

The present invention provides a new approach to reducing piracy of content, as used in video-on-demand (VOD) TV or Internet systems. FIG. 1 shows a packet of the VOD signal with content, that is sent from the content provider or headend. The present invention inserts, between the header and the data which includes the content, as shown in FIG. 1, a series of bits, which are used to signal the start of content data (SOD), and to assist in decrypting the digitized video signal. Content, as used in the art, also refers to digital content.

A user who copies a rented compact disk (CD), or who downloads from the Internet a bit stream containing content, is inhibited from viewing the video. The SOD includes an odd number of bits which are not recognized by the currently standard television receiver or set top box (STB). The SOD are removed using circuitry placed in television sets built accordingly to the present invention. Thus, a digital video recorder (DVR) or other recording device placed at the input to the television will record the SOD and encrypted video. The pirate will be unable to achieve line or frame synchronization, and will be unable to remove the encryption without opening the television set built according to the present invention. Furthermore, the SOD code can be changed periodically or at headend control, or using a smart card or public key technology.

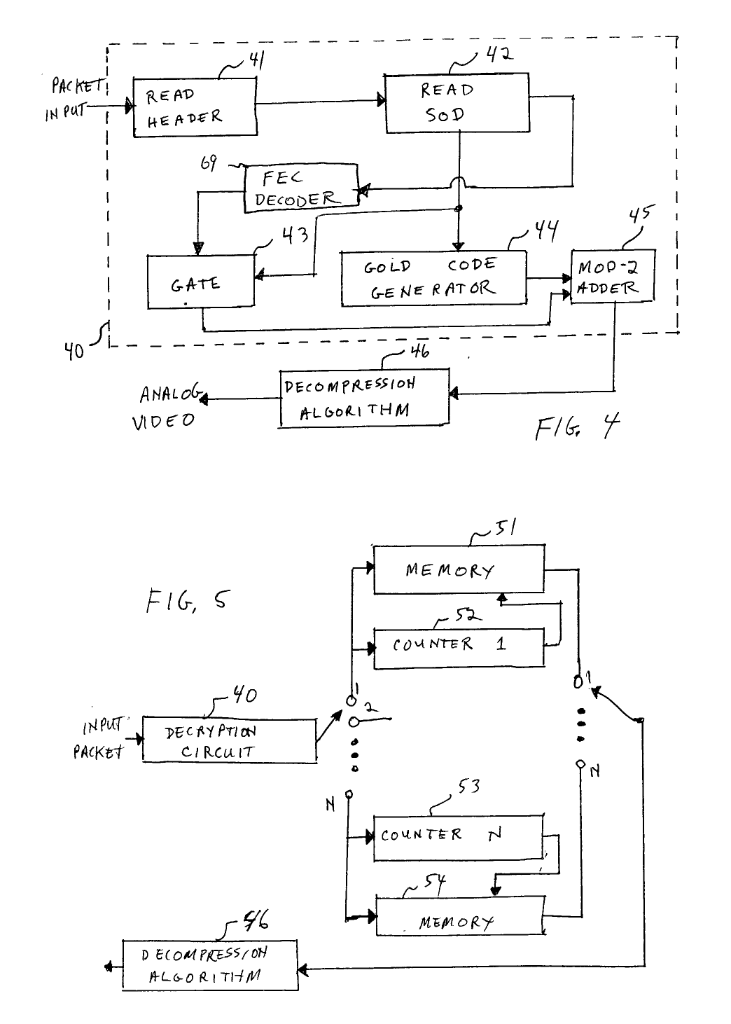

The improvement to a television-content distribution system includes a Gold-code generator, as shown in FIG. 2, which provides the security code, and a code adjust subsystem 37; an FEC encoder 19, and a multiplexer 33, which forms the packet having the header, code-adjust and encrypted/encoded data, as shown in FIG. 3; a second header subsystem 41, a start-of-data subsystem 42, a FEC decoder 69, a second Gold-code generator 44, which security decodes the encrypted data using the security decoder using the mod-2 adder 45 and a decompressing subsystem 46, as shown in FIG. 4.

The security encoder includes a first Gold code generator, as shown in FIG. 2, which is connected, or coupled, to a modulo-2 adder, 32, and to the digital-compression subsystem 31. The output of the modulo-2 adder 32 is connected or coupled to the FEC encoder 19, which is connected or coupled to a multiplexer 33. The multiplexer 33 is coupled or connected to the code-adjust subsystem 37.

The first Gold-code generator, FIG. 2, generates a first Gold-code sequence signal. Gold code sequences are well known in the art, and FIG. 2 shows a representative Gold code generator, with the addition of the code-adjust subsystem 37. The code-adjust subsystem 37 presets the start position of the second pseudo-noise (PN) generator thereby permitting 2^{N} codes, where N is the length of the shift register. The security encoder 32 encodes the digitized-compressed content with the first Gold-code signal. The security encoding produces an encoded-digitized-compressed content. The security encoded-digitized-compressed content is then FEC encoded by the FEC encoder 19.

The code-adjust sub-system 37 generates a code-adjust signal. The code-adjust signal determines the Gold code from the first Gold code generator. The first header subsystem generates a header with a user address. The multiplexer 33 multiplexes the code-adjust signal and the header to the FEC encoded-digitize-compressed content. The resulting multiplexed signal is a packetized-compressed-video signal.

The second header subsystem 41, typically located at a user's STB, reads the header from the packetized-compressed-video signal. The start-of-data subsystem 42 reads the code-adjust signal from the packetized-compressed-video signal, thereby setting the proper code of the Gold Code generator. The FEC decoder 69, FEC decodes the signal. The code-adjust signal controls gate 43, for synchronizing the second Gold code generator 44. Using the code-adjust signal read from the SOD 42, the second Gold-code generator 44 generates a second Gold-code signal, synchronized from the code-adjust signal. The security decoder 45 decodes the encoded-digitized-compressed content with the second Gold-code signal, thereby generating digitized-compressed content. The decompressing subsystem 46 decompresses the digitized-compressed content as content.

Video, at present, is digitized using one of the many available compression techniques. Standard techniques include MPEG-2 and MPEG-4. The present invention has the digitized, compressed video preceded by a header, followed by the start-of-data signal, as shown in FIG. 1. The header is typically related to the address of the user who requested the video.

The digitized, compressed video signal is security encoded or encrypted using a first Gold code, or similar binary sequence for encoding or encrypting. The code shifts used to form the binary sequence encryption code are contained in the SOD portion of the packet of FIG. 1. The resulting signal is FEC encoded.

The resulting packet is transmitted to the STB of the user requesting the video. The STB of the appropriate user recognizes the header of FIG. 1. The header is removed from the data by the second header subsystem 41. The SOD is removed by the second SOD subsystem 42. The encrypted or security-encoded data are FEC decoded and then decoded or decrypted by security decoder 45, using a second Gold code, which is a replica of the first Gold code, to security encode the packet. The second Gold code is generated by second Gold code generator 44.

Synchronization for a packet is obtained from reading the header by the second header subsystem 41. The SOD from SOD subsystem 42 sets the decoding or decryption code shifts, and thereby controls gate 43, to decode or decrypt the data. The encrypted video data and the PN Gold code are correlated. The result is decoded video data.

FIG. 2 shows a typical Gold code generator. Other sequence generators could be used, in place of the Gold code generator. The code-adjust subsystem 37 shifts the code start position of PN-2 39 prior to forming the Gold code. If PN-1 38 and PN-2 39 each were 31 registers long, then there are 2³¹ possible shifts in PN-2 before the code L=2³¹ repeats. Thus, there are 2³¹ possible Gold codes, each of length, L=2³¹. A smart card can be used to periodically change taps of PN-1 and PN-2, to generate different codes. The different codes will not necessarily be Gold codes but can be used to security encode or encrypt the video. After adjusting the code, the clock 28 shifts both PN-1 and PN-2, simultaneously, forming the output Gold code sequence. Each shift register 38, 39 is connected to an adder 35, 36, respectively, as is well-known in the art. The output of each shift register 38, 39 is combined by modulo-2 adder 29, to form the Gold code.

FIG. 3 shows the analog video being compressed by digital compression algorithm 31, FEC encoded by FEC encoder 19, and then encrypted by modulo-2 adder 32 with the Gold code. The encoded, encrypted, compressed data are put in memory 34, shown as a shift register, and the code-adjust value, SOD, and the header, containing the user address, are combined as a packet. The resulting packet is ready for transmitting.

FIG. 4 shows the output of the STB. Within the STB, in U.S. patent application entitled VARIABLE DATA RATE ENTERTAINMENT SYSTEM AND METHOD, and having Ser. No. 10/218,990 with filing date of Aug. 14, 2002, incorporated herein by reference, a fast Fourier transform (FFT) may be employed to combine the data from all of the borrowed channels. The resulting data are shown in FIG. 4 as an input packet.

To avoid piracy the circuit implementing the block diagram of FIG. 4 should be placed within the television or computer. The received input packet's header is read by the second header subsystem 41 of the user requesting the VOD, since the header includes the user's address. The SOD is then read by SOD subsystem 42 and the Gold code appropriately is adjusted. The video transmission then is modulo-2 added by modulo-2 adder 45 to the Gold code output from Gold code generator 44 to decode or decrypt the data. The decrypted data then is decompressed by decompression algorithm 46 and can be viewed. Since the circuitry implementing the block diagram of FIG. 4 preferably is within the television or computer, a Digital Video Recorder (DVR), placed at the television input or computer input, would receive only encrypted data. Output control signals from SOD subsystem 42 are used to adjust the Gold code within the Gold code generator 44 with respect to the Gold code within the packet. A gate 43, which is optional, may assist in the adjustment and the control of modulo-2 adder 45.

A pirate may open the television to get to the analog video input. However, at that point, the analog color signal and the TV monitor's synchronizing signal have been separated. Thus, the analog movie reconstruction process is now extremely complex and expensive. Further, eventually all TVs and computers will be built to have the decoding box internal. Therefore, since the addresses between users are different, and the SOD codes are different from user to user, piracy is eliminated. The use of a smart card can change taps on the Gold code generator. The resulting code generator then would not be a Gold code generator, but it still may provide adequate encoding or encryption security. The end result is that while the movie could be reconstructed, the pirate would not know each of his customer's address and SOD. Thus piracy is ended.

The subsystem used to limit rental time of the VOD is shown in FIG. 5. The input packet goes through the decryption subsystem 40 illustrated in FIG. 4. The signal then starts a time counter, for example, a 72 hour counter, and the decrypted video is stored in memory 51. After the time counter counts, for example, 72 hours, the memory is erased. Other time durations could be used and the number of showings of the VOD could be used in lieu of time durations. In FIG. 5, N, VODs simultaneously can be stored in memories 51, 54. Each memory has a respective counter 52, 53. To view a particular VOD, the user requests the appropriate memory number. Following standard practice, the VOD can be started, stopped, put into a FFW or REV or PAUSE mode. These techniques are well known in the art and do not form part of this invention.

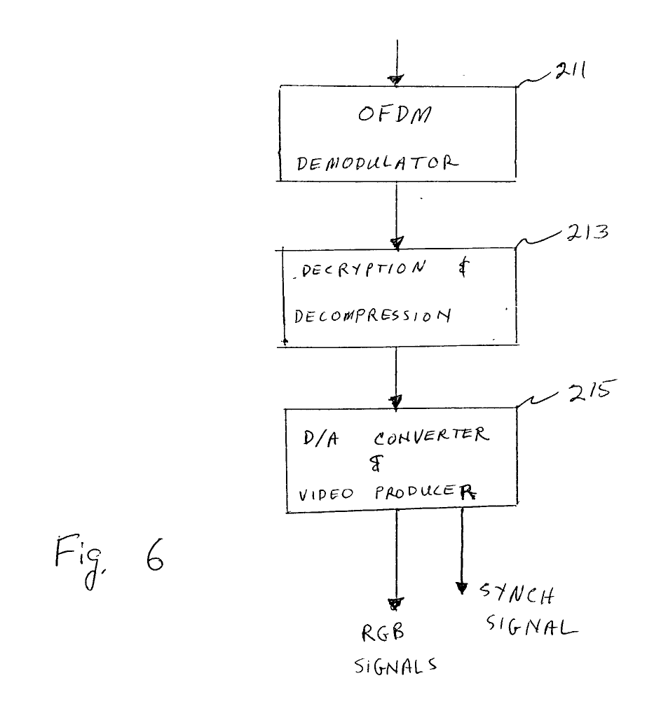

FIG. 6 shows an a block diagram at a RSU. For as cable input, by way of example, an OFDM signal is received, and an OFDM demodulator 211 OFDM demodulates the OFDM signal. The OFDM demodulator essentially collects incoming signals, which are FED decoded, and combines the incoming signals into a single data stream. The data are address dependent.

The decryption/decompression module 213 decrypts the data and decompresses the data. The data are address dependent.

The D/A converter and video producer module digital-to-analog converts the data, and separates the video signal from the synchronization signal. Data are address dependent. The output is a standard RGB signal and synchronization signal.

It will be apparent to those skilled in the art that various modifications can be made to the piracy prevention system and method of the instant invention without departing from the scope or spirit of the invention, and it is intended that the present invention cover modifications and variations of the piracy prevention system and method provided they come within the scope of the appended claims and their equivalents.

I claim:

1. An improvement to a television channel distribution system having digitized-compressed content, comprising:
a first Gold-code generator, for generating a first Gold-code sequence signal;
a security encoder/encrypter for encrypting the digitized-compressed content with the first Gold-code signal, thereby generating encoded-digitized-compressed content;
a code-adjust sub-system for generating a code-adjust signal for determining the Gold code from the first Gold code generator;
a forward-error-correction (FEC) encoder for FEC encoding the encoded-digitized-compressed content;
a first header subsystem for generating a header with a user address;
a multiplexer for multiplexing the code-adjust signal and the header to the encoded-digitize-compressed content, thereby generating a packetized-compressed-video signal;
a second header subsystem for reading the header from the packetized-compressed-video signal;
a start-of-data subsystem for reading the code-adjust signal from the packetized-compressed-video signal;
a second Gold-code generator, responsive to the code-adjust signal read from the packetized-compressed-video signal, for generating a second Gold-code signal, synchronized from the code-adjust signal;
a FEC decoder for error correction;
a decoder, coupled to the second Gold-code generator, for decoding the encoded-digitized-compressed content with the second Gold-code signal, thereby generating unencrypted, digitized-compressed content; and
a decompressing subsystem for decompressing the digitized-compressed content as content.

2. An improvement to a television channel distribution method having digitized-compressed content, comprising the steps of:
generating a first Gold-code sequence signal;
security encoding the digitized-compressed content with the first Gold-code signal, thereby generating encoded-digitized-compressed content;
generating a code-adjust signal;
forward-error-correction (FEC) encoding the encoded-digitized-compressed content;
generating a header with a user address;
multiplexing the code-adjust signal and the header to the encoded-digitize-compressed content, thereby generating a packetized-compressed-video signal;
reading the header from the packetized-compressed-video signal;
reading the code-adjust signal from the packetized-compressed-video signal;
generating, in response to the code-adjust signal read from the packetized-compressed-video signal, a second Gold-code signal, synchronized from the code-adjust signal;
FEC decoding the packetized-compressed-video signal;
decoding the encoded-digitized-compressed content with the second Gold-code signal, thereby generating digitized-compressed content; and
decompressing the digitized-compressed content as content.

3. An improvement to a television channel distribution system having digitized-compressed content, comprising:
a first Gold-code generator, for generating a first Gold-code sequence signal;
a security encoder/encrypter for encrypting the digitized-compressed content with the first Gold-code signal, thereby generating encoded-digitized-compressed content;
a code-adjust sub-system for generating a code-adjust signal for determining the Gold code from the first Gold code generator;
a start-of-data subsystem for reading the code-adjust signal from the packetized-compressed-video signal;
a second Gold-code generator, responsive to the code-adjust signal read from the packetized-compressed-video signal, for generating a second Gold-code signal, synchronized from the code-adjust signal; and
a decoder, coupled to the second Gold-code generator, for decoding the encoded-digitized-compressed content with the second Gold-code signal, thereby generating unencrypted, digitized-compressed content.

4. An improvement to a television channel distribution method having digitized-compressed content, comprising the steps of:
generating a code-adjust signal for determining a first Gold-code signal;
generating, responsive to the code-adjust signal, the first Gold-code sequence signal;
security encoding the digitized-compressed content with the first Gold-code signal, thereby generating encoded-digitized-compressed content;
reading the code-adjust signal from a packetized-compressed-video signal;
generating, in response to the code-adjust signal read from the packetized-compressed-video signal, a second Gold-code signal, synchronized from the code-adjust signal; and
decoding the encoded-digitized-compressed content with the second Gold-code signal, thereby generating digitized-compressed content.

5. The improvement as set forth in claim 1, further including:
a memory, located at the RSU, for storing received content;
a time counter, coupled to said memory, for determining a time duration; and
a controller, responsive to the time duration, for erasing the content stored in said memory.

6. The improvement as set forth in claim 2, further including:
storing, at the RSU, received content;
determining a time duration; and
erasing, responsive to the time duration, the stored content.

7. The improvement as set forth in claim 1, further including said second header subsystem for reading a synchronization signal from the packetized-compressed-video signal, with the synchronization signal separate from the content.

8. The improvement as set forth in claim 2, further including the step of reading a synchronization signal from the packetized-compressed-video signal, with the synchronization signal separate from the content.

9. The improvement as set forth in claim 1, further including:
a memory, located at the RSU, for storing a plurality of received content;
a time counter, coupled to said memory, for determining a plurality of time durations, corresponding to the plurality of received content, respectively; and
a controller, responsive to the plurality time durations, for erasing a respective received content of the plurality of received content when the respective time duration expires.

10. The improvement as set forth in claim 2, further including:
storing a plurality of received content;
determining a plurality of time durations, corresponding to the plurality of received content, respectively; and
erasing, responsive to a respective time duration of the plurality of time durations, a respective received content of the plurality of received content when the respective time duration expires.

11. An improvement to a television channel distribution system having digitized content, comprising:
a first Gold-code generator, for generating a first Gold-code sequence signal;
a security encoder/encryptor for encrypting the digitized content with the first Gold-code signal, thereby generating encoded-digitized content;
a code-adjust sub-system for generating a code-adjust signal for determining the Gold code from the first Gold code generator;
a first header subsystem for generating a header with user address;
a multiplexer for multiplexing the code-adjust signal and the header to the encoded-digitize content, thereby generating a packetized-compressed-video signal;
a second header subsystem for reading the header from the packetized-video signal;
a start-of-data subsystem for reading the code-adjust signal from the packetized-video signal;
a second Gold-code generator, responsive to the code-adjust signal read from the packetized-video signal, for generating a second Gold-code signal, synchronized from the code-adjust signal; and
a decoder, coupled to the second Gold-code generator, for decoding the encoded-digitized content with the second Gold-code signal, thereby generating unencrypted, digitized-compressed content.

12. An improvement to a television channel distribution method having digitized content, comprising the steps of:
generating a first Gold-code sequence signal;
security encoding the digitized content with the first Gold-code signal, thereby generating encoded-digitized content;
generating a code-adjust signal;
generating a header with a user address;
multiplexing the code-adjust signal and the header to the encoded-digitized content, thereby generating a packetized-video signal;
reading the header from the packetized-video signal;
reading the code-adjust signal from the packetized-compressed-video signal;
generating, in response to the code-adjust signal read from the packetized-video signal, a second Gold-code signal, synchronized from the code-adjust signal; and
decoding the encoded-digitized content with the second Gold-code signal, thereby generating digitized content.

13. The improvement as set forth in claim 1 or 11, with the code-adjust sub-system for generating a code-adjust signal unique for a RSU of a plurality of RSUs, for determining the Gold code, corresponding to the unique RSU, from the first Gold code generator.

14. The improvement as set forth in claim 2 or 12, with the step of generating a code-adjust signal including the step of generating a code-adjust signal unique for a RSU of a plurality of RSUs, for determining the Gold code, corresponding to the unique RSU, from the first Gold code generator.

15. The improvement as set forth in claim 1 or 11, with a television including the second Gold-code generator and the decoder.

16. The improvement as set forth in claim 2 or 12, with the steps of generating the second Gold-code signal and decoding including the steps of:
generating, inside a television, the second Gold-code signal; and
decoding, inside the televison, with the second Gold-code signal.

17. The improvement as set forth in claim 1 or 11, further including said second header subsystem for reading a synchronization signal and RGB signals from the depacketized-decompressed-video signal, with the synchronization signal and RGB signals separate from each other.

18. The improvement as set forth in claim 2 or 12, further including the step of reading a synchronization signal and RGB signals from the packetized-compressed-video signal, with the synchronization signal and RGB signals separate from each other.

19. The improvement as set forth in claim 16, further including said second header subsystem for reading a synchronization signal and RGB signals from the depacketized-decompressed-video signal, with the synchronization signal and RGB signals separate from each other.
